(19) United States
(12) Patent Application Publication
(10) Pub. No.: US 2010/0328622 A1
(43) Pub. Date: Dec. 30, 2010

(54) PROJECTION DISPLAY APPARATUS

(76) Inventors: Norihiro WATANABE, Tokyo (JP); Satoru Okagaki, Tokyo (JP); Atsushi Michimori, Tokyo (JP); Norichika Sugano, Tokyo (JP); Kazuo Kadowaki, Tokyo (JP); Tomomi Matsui, Tokyo (JP)

Correspondence Address: BIRCH STEWART KOLASCH & BIRCH, PO BOX 747, FALLS CHURCH, VA, 22040-0747, US

(21) Appl. No.: 12/732,776

(22) Filed: Mar. 26, 2010

(30) Foreign Application Priority Data
Jun. 24, 2009 (JP) 2009-149814

(51) Int. Cl. G03B 21/10

(52) U.S. Cl. 353/77; 353/74

(57) ABSTRACT

A projection image display apparatus is provided which is capable of preventing misregistration in an on-screen image. A main frame assembly holds together an optical engine that modulates light emitted from a light source and a screen on which light emitted from the optical engine is projected, and the main frame assembly is configured to be supported by a bottom frame formed by a separate structure, whereby distortion having occurred at the bottom frame is caused not to transmit to the main frame assembly.

### FIELD OF THE INVENTION

The present invention relates to cabinet structures of a projection display apparatus.

### BACKGROUND OF THE INVENTION

In a projection display apparatus, light from the light source is modulated into imaging light and the imaging light is reflected using a mirror and then projected on a screen where images are displayed. A conventional projection display apparatus is configured with a bottom cabinet on which a light source and an optical engine are mounted, a rear cover supported by the bottom cabinet, a mirror that is attached to the rear cover and reflects imaging light from the optical engine, a screen on which the imaging light reflected by the mirror, and a front cover on which the screen is mounted (refer to Japanese Unexamined Patent Application Publication No. 2008-76901 (page 9, FIG. 5), which is thereafter called Patent Document 1). Another conventional projection display apparatus is such that a light source and an optical unit are disposed in a bottom frame, and light emitted upwardly through the apparatus from the optical unit is reflected by a projection mirror supported by a top frame and then projected toward a screen held by a structure including the bottom frame, a left-hand and a right-hand frames, and the top frame (refer to Japanese Unexamined Patent Application Publication No. 2007-183301 (page 5, FIG. 5), which is thereafter called Patent Document 2).

A problem with Patent Document 1 above is that because the bottom cabinet holds the optical engine, the relative positional relationship between the optical engine and the mirror held by the rear cover or the screen held by the front cover, is likely to vary, and misregistration in an on-screen image tends to occur. Another similar problem with Patent Document 2 above is that because a bottom frame holds an optical unit, the relative positional relationship between the optical unit and a projection mirror held by a top frame or a screen held by a structure, is likely to vary, and misregistration in an on-screen image tends to occur.

### SUMMARY OF THE INVENTION

The present invention is directed to overcome the above-described problems and the object thereof is to provide a projection display apparatus capable of preventing misregistration in an on-screen image.

A projection display apparatus according to the present invention includes a light source that emits light, an optical engine that modulates light emitted from the light source, a screen on which light emitted from the optical engine is projected, a main frame assembly that holds the optical engine and the screen, and a bottom frame that supports the main frame assembly.

Another projection display apparatus according to the present invention includes a light source that emits light; an optical engine that modulates light emitted from the light source; a screen on which light emitted from the optical engine is projected; and a main frame assembly including a holding frame that holds the optical engine, a screen frame that is connected to the holding frame and holds the screen, and a rear frame that is connected to the holding frame and the screen frame, wherein the upper end portion of the screen frame is connected with a first end portion of the rear frame, a second end portion of the rear frame is connected with the upper end portion of the holding frame, and the lower end portion of the holding frame is connected with the lower end portion of the screen frame.

A projection display apparatus according to the present invention allows misregistration in an on-screen image to be avoided. These and other objects of the present invention will be better understood by reading the following detailed description in combination with the attached drawings of a preferred embodiment of the invention.

### BRIEF DESCRIPTION OF THE DRAWINGS

FIG. 1 is a schematic diagram showing an optical system of a projection display apparatus according to Embodiment 1 of the present invention;

FIG. 2 is a rear perspective view showing a cabinet structure of the projection display apparatus according to Embodiment 1 of the present invention;

FIG. 3 is an exploded perspective view showing the cabinet structure of the projection display apparatus according to Embodiment 1 of the present invention;

FIG. 4 is a side elevational view showing an outline of a frame configuration of the projection display apparatus according to Embodiment 1 of the present invention;

FIG. 5 is a cross-sectional view showing the projection display apparatus according to Embodiment 1 of the present invention, with the apparatus placed on an uneven floor;

FIG. 6 is an exploded perspective view showing a configuration of a rear cover structure of the projection display apparatus according to Embodiment 1 of the present invention;

FIG. 7 is a perspective view showing the projection display apparatus according to Embodiment 1 of the present invention, with a top mirror disposed at a rear frame;

FIG. 8 is a perspective view showing a structure for suspending the top mirror in the projection display apparatus according to Embodiment 1 of the present invention;

FIG. 9 is a cross-sectional view showing a projection display apparatus according to Embodiment 2 of the present invention, with the apparatus hung on a wall;

FIG. 10 is a cross-sectional view showing the projection display apparatus according to another embodiment of the present invention;

FIG. 11 is an exploded perspective view of a projection display apparatus according to Embodiment 4 of the present invention; and

FIG. 12 is a perspective view showing a supporting plate in a projection display apparatus according to another embodiment of the present invention.

### DESCRIPTION OF THE PREFERRED EMBODIMENTS

### Embodiment 1

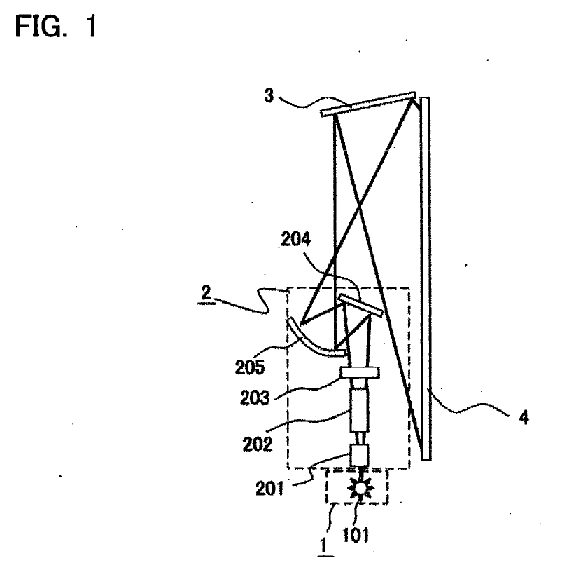

Embodiment 1 of the present invention will be described referring to the foregoing figures. FIG. 1 is a schematic diagram showing an optical system of a projection display apparatus according to Embodiment 1 of the present invention. Referring to FIG. 1, the optical system of the projection display apparatus is configured with a light source unit 1, an optical engine 2, a top mirror 3, and a screen 4. The light source unit 1 includes a light source 101. The optical engine 2 is configured with a dichroic prism 201, a mixing rod 202, a digital mirror device (DMD) 203, a reflective mirror 204, and a nonplanar mirror 205.

A light source unit 101 is configured with three laser generators that emits light of three colors, red, blue and green; three laser beams each of a different wavelength are emitted from the light source unit 1 to the optical engine 2. The dichroic prism 201 of the optical engine 2 is combination means that combines together the three laser beams from the light source unit 1. The mixing rod 202 is an intensity uniformization element that uniformizes intensity distribution of the laser beams combined using the dichroic prism 201. The DMD 203 is modulation means that provides information by space modulating the laser beams uniformized using the mixing rod 202, based on imaging signals supplied from an external unit. The reflective mirror 204 reflects the laser beams modulated using the DMD 203 toward the nonplanar mirror 205 that in turn reflects to the top mirror 3 the laser beams reflected by the reflective mirror 204. Since a reflection surface of the nonplanar mirror 205 is formed so that the reflected beams may be collected and thereafter diffuse, the divergence angle of the laser beams to be reflected can be increased. The top mirror 3, which is disposed at a position higher than the optical engine 2, reflects toward the screen 4 the light emitted upwardly from the optical engine 2. The laser beams reflected by the top mirror 3 are projected onto the screen 4, whereby images corresponding to imaging signals supplied to the DMD 203 are displayed on the screen 4.

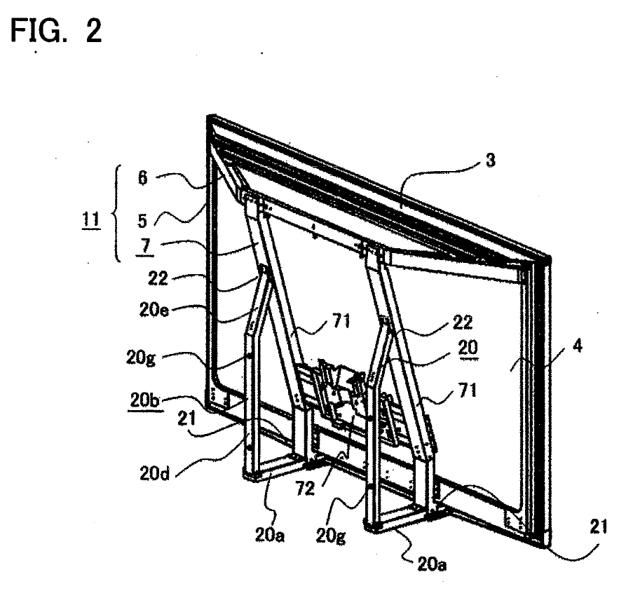

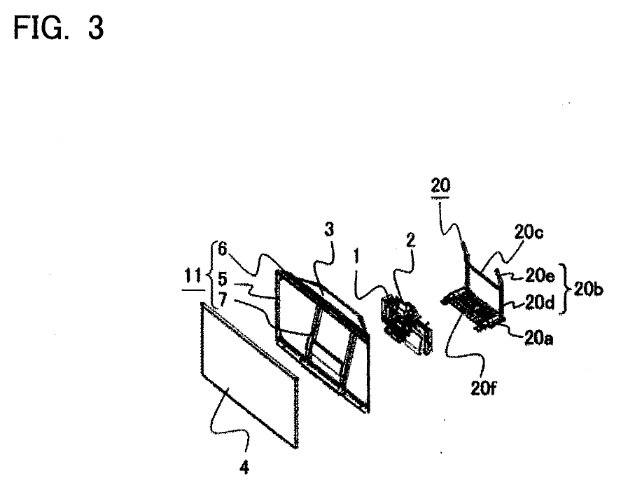

FIG. 2 is a rear perspective view showing a cabinet structure before installing the light source unit 1 and the optical engine 2 to the cabinet structure. FIG. 3 is an exploded perspective view showing the cabinet structure of the projection display apparatus. In FIGS. 2 and 3, components that are the same as, or corresponding to, the components in FIG. 1 bear the same numerals, and their description is not provided.

Referring to FIGS. 2 and 3, the cabinet of the projection display apparatus is configured with a main frame assembly 11, and a bottom frame 20 that is secured to the rear of the main frame assembly 11 and in a self-standing position on the floor. The main frame assembly 11 and the bottom frame 20 are of separate construction from each other. The main frame assembly 11 is configured with a screen frame 5 that holds the screen 4, a rear frame 6 that holds the top mirror 3, and a holding frame 7 that holds the light source unit 1 and the optical engine 2.

The rear frame 6, which is trapezoid-shaped, is screw-secured to both end portions of the upper side of the rectangular screen frame 5. The holding frame 7 is configured with two holding members 71 of rectangular solid shape—which are left-right symmetrically disposed on the rear side of the screen 4, and extend vertically—and a connecting member 72 that connects the two holding members 71 together. The two holding members 71 are screw-secured at their upper end portions to the rear frame 6, and at their lower end portions to the lower side of the screen frame 5. In this manner, the screen frame 5, the rear frame 6, and the holding frame 7 are secured to each other by screws. Here, the light source unit 1 and the optical engine 2 are attached to the connecting member 72.

The rear frame 6 holding the top mirror 3 is placed at a slant, in a rear-to-front direction, from the upper portion over to the lower portion of the cabinet using the holding frame 7. This arrangement allows the holding frame 7 to bear the load of the top mirror 3 and to play a role of a supporting stick. As a result, the moment to be created on the screen frame 5 to which the rear frame 6 is attached, and the moment of the rear frame 6 per se can be reduced. The screen frame 5, the rear frame 6, and the holding frame 7, constituting the main frame assembly 11, are each formed of an aluminum material for the sake of achieving light weight.

As shown in FIG. 2, the bottom frame 20 includes two bottom members 20a disposed substantially in parallel on the floor, two column members 20b each perpendicularly extending upwardly from each corresponding bottom member 20a, and a connecting member 20c for connecting the two column members 20b together. The two bottom members 20a and the two column members 20a are formed so as to be two substantially L-shaped legs supporting the main frame assembly 11. Each of the column members 20b includes a straight sub-member 20d and a slanted sub-member 20e that is provided on the upper side of the straight sub-member 20d and slanted toward the holding frame 7 with respect to the longitudinal direction of the straight sub-member 20d. The bottom members 20a and the column members 20b, each combination of the members constituting the two legs, are formed of soft-iron plates for the sake of providing the needed strength. Formed on each of the bottom members 20a of the bottom frame 20 is a lower connecting portion 21 to which the lower end portion of the holding frame 7 is screw-secured. The upper end portion of the slanted sub-member 20e is screw-secured at an upper connecting portion 22 to the holding frame 7. Here, illustrations of the bottom plate member 20f and the connecting member 20c, as shown in FIG. 3, are not provided in FIG. 2.

The projection display apparatus can be placed on a base such as a low board, with the bottom members 20a of the bottom frame 20 serving as the bearing surface as shown in FIG. 2; however, as shown in FIG. 3, a bottom plate member 20f, additionally provided under the bottom members 20a, can serve as the bearing surface. The provision of the bottom plate member 20f can enhance dust proofing. Moreover, the formation of the bottom plate member 20f with a low stiffness material like plastic can reduce the stiffness at the foot of the projection display apparatus. As a result, the stiffness in the case where a force is applied from the bottom can be reduced while the stiffness in a gravity direction of the column members 20b (the traverse direction of the screen 4) is being maintained at a level sufficient to support the main frame assembly 11. Here, four holes 20g formed on the straight sub-members 20d are holes for wall-mounting the projection display apparatus. An embodiment for the wall-mounting will be described later.

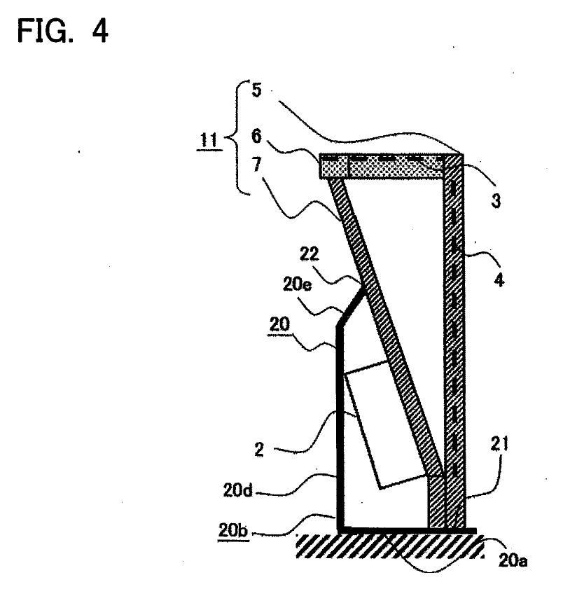

FIG. 4 is a side elevational view showing an outline of a frame construction of the projection display apparatus. Components that are the same as, or corresponding to, the components in FIGS. 1 through 3 bear the same numerals, and their description will not be provided herein. As shown in FIG. 4, the main frame assembly 11 is constructed to resemble a triangular truss structure, as viewed from the side, and such structure thus provides high stiffness. In other words, when coupling together the three frames—the screen frame 5, the rear frame 6 and the holding frame 7—one frame is coupled to the other two frames so that a partial force exerted on the one frame is produced in the longitudinal direction of members constituting the other two frames, whereby the stiffness of the main frame assembly 11 can be increased.

Since each of the two column members 20b has the slanted sub-member 20e, the connecting structure formed by the bottom frame 20 and the main frame assembly 11 is a pentagon, as viewed from the side, that is shaped by a closed line extending from the lower connecting portion 21, via the bottom member 20a, the straight sub-member 20d, the slanted sub-member 20e and the upper connecting portion 22, and then back to the lower connecting portion 21, as shown in FIG. 4. Since the pentagonal shape is more vulnerable to mechanical deformation than the triangular shape, the stiffness of the bottom frame 20 when compared to the main frame assembly 11 can be reduced. Further, each member constituting the bottom frame 20 is made thin-walled in order to lower the stiffness of the bottom frame. In this way, since the bottom frame 20 is formed to be lower in stiffness than the main frame assembly 11, external force, even if applied to the bottom frame 20, is accommodated by the bottom frame 20, which resists misalignment of optical components on the main frame assembly 11.

Next, in terms of the frame structure thus constructed of the projection display apparatus, an effect of installation conditions on the apparatus will be described. For comparison, a conventional projection display apparatus is placed on an uneven floor, as will be first described. Installing the conventional projection display apparatus on the uneven floor causes the effect to transmit from the bottom members 20a of the bottom frame 20 to the cabinet. Assuming that the cabinet is a rigid body, the cabinet will slant with respect to the ground surface owing to the floor unevenness; however, because of the cabinet not being deformed, relative positions of the optical engine 2, the top mirror 3 and the screen 4 do not vary, thus causing no misregistration in an image. However, actually, a distortion arises because the cabinet is not a rigid body. Unevenness of the floor causes the bottom members 20a of the bottom frame 20 to distort, and the distortion is transmitted to the holding frame 7. The distortion transmitted to the holding frame 7, in turn, transmits to the screen frame 5; thus, the relative positions of the optical engine 2, the top mirror 3 and the screen 4 are resultingly displaced, thereby causing misregistration in an image.

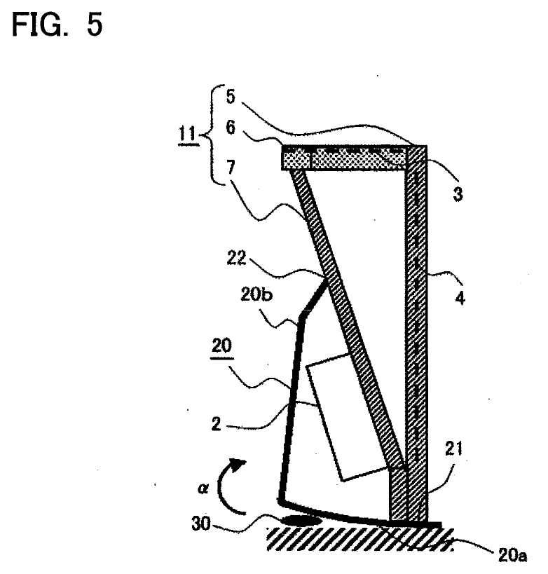

On the other hand, even when the projection display apparatus according to Embodiment 1 is placed on the uneven floor, the relative positions between the optical engine 2, the top mirror 3 and the screen 4 does not vary due to the following reason. The reason will be described with reference to FIG. 5. FIG. 5 is a sectional view generally showing the bottom frame 20 that distorts when the apparatus rides over a bump 30 on the floor. Referring to FIG. 5, because the bottom frame 20 has the two column members 20b that are separate left and right ones as shown in FIGS. 3 and 4, only one of the column members 20b deforms so as to be twisted in an α direction in FIG. 5. At this moment, although, because the bottom frame 20 is constructed to be lower in stiffness than the main frame assembly 11, the bottom members 20a of the bottom frame 20 deform as shown in FIG. 5, the main frame assembly 11 undergoes little deformation. In this way, because there is little deformation that occurs in the main frame assembly 11 having optical components disposed and most of the deformation occurs on the bottom frame 20, each of the relative positions of the optical engine 2, the top mirror 3 and the screen 4 is resultingly maintained. Consequently, the image display apparatus according to Embodiment 1 is hard to undergo the effect due to the floor unevenness.

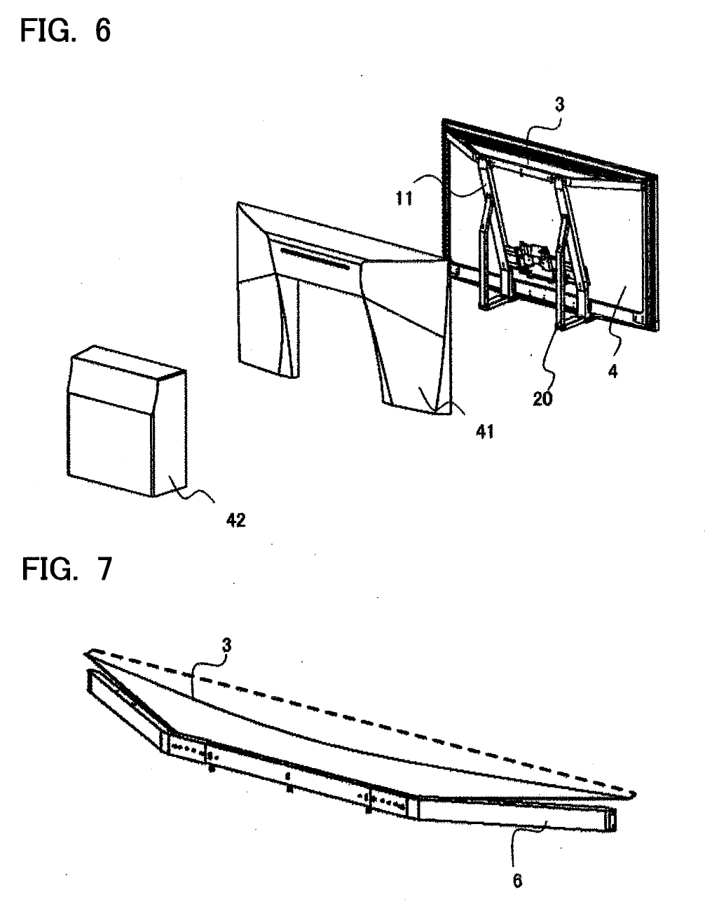

FIG. 6 is an exploded perspective view showing a configuration of a rear cover. Components that are the same as, or corresponding to, the components in FIG. 3 bear the same numerals, and their description will not be provided. Referring to FIG. 6, the rear cover is a cover that covers the rear of the cabinet so that light emitted from the light source unit 1 or the optical engine 2 does not leak out of the apparatus, and is configured with a first rear cover 41 and a second rear cover 42. The first rear cover 41 covers the main frame assembly 11 and is fastened thereto. The second rear cover 42 covers the bottom frame 20 and is fastened thereto.

Configuring a rear cover with a single part results in fastening the rear cover of the single part to the main frame assembly 11 and the bottom frame 20. For that reason, a problem is that the deformation of the bottom frame 20 is transmitted via the rear cover to the main frame assembly 11, thus resulting in the main frame assembly 11 being deformed and in varying the relative positions of the optical components.

On the other hand, as described above, if the first rear cover 41 and the second rear cover 42 are configured with different parts, then the distortion transferred to the second rear cover 42 owing to the deformation of the bottom frame 20 is not transferred to the first rear cover 41. Therefore, the main frame assembly 11 is hard to be affected by the deformation of the bottom frame 20.

Next, the top mirror 3 will be described with reference to FIG. 7. FIG. 7 is a perspective view showing the top mirror 3 that is disposed at the rear frame 6. Because the top mirror 3 is used for a large type of the image display apparatus, it is very large on the order of 1.6 meters in longitudinal dimension when used for a 75-inch screen. Because a glass with about 3 mm thickness is typically used, the glass deforms, as shown in solid line in FIG. 7, so as to lower, owing to its own weight, its center by about 6 mm from a predeformation shape shown by the dotted lines. On the other hand, because, when projecting the image, the deformation of the top mirror 3 automatically causes deformation in image, the deformation due to its own weight needs to be reduced.

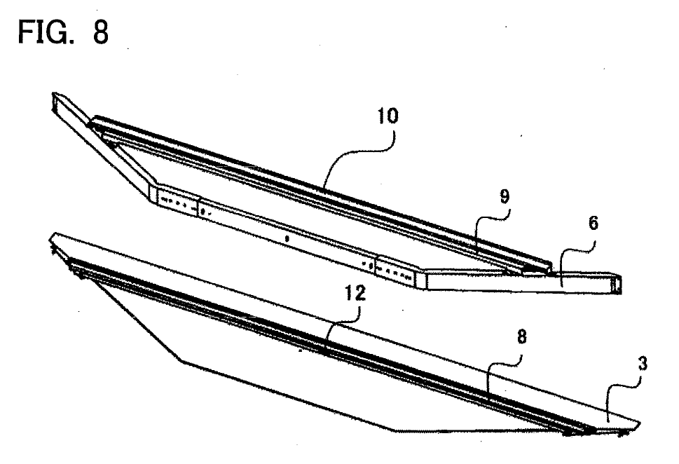

FIG. 8 is a perspective view showing a supporting construction for the top mirror 3, in the projection display apparatus. In FIG. 8, in order to reduce deformation due to its own weight, the beam member 8 is adhered to the rear of the top mirror 3 using a double-sided adhesive, etc., and the apparatus is configured to suspend the substantially center portion of a beam member 8 by hooking to a hook 12 formed on the beam member 8 a hook 10 jutting out from the reinforcing frame 9 provided in the center of the rear frame 6. In this way, the suspension construction of the top mirror 3 is configured in which planarity is ensured by lifting the top mirror 3 at its center portion where it deforms greatly under its own weight.

On the other hand, it is conceivable that only the reinforcing member ensures the planarity of the top mirror 3, while it is conceivable that reinforcement with consideration of deformation due to its own weight of the reinforcing member is needed, thus leading to significant increase of the weight. Because the configuration according to Embodiment 1 does not need to increase the stiffness of the reinforcing member when compared to the construction where the deformation is reduced by stiffness, an advantage is that a lighter weight frame can be configured.

In the projection display apparatus where light emitted from the light source unit 1 is reflected by the top mirror 3 and then projected on the screen 4, since the optical path from the light source unit 1 to the screen 4 is long, misalignment of an angle between optical components by merely 0.1 degrees causes the image on the screen 4 to come out of registration by nearly 10 mm; however, as in the projection display apparatus according to Embodiment 1, by putting all the optical components in the main frame assembly 11 and supporting the main frame assembly 11 by the bottom frame 20, misalignment of the optical components can be avoided and misregistration in an image on the screen 4 can be reduced.

As described above, since, in the projection display apparatus according to the present invention, the screen frame 5, the rear frame 6 and the holding frame 7 are integrally configured as the main frame assembly 11, accuracy in assembling the optical engine 2, the top mirror 3, and the screen 4, that are held by such frames, is easy to ensure, thus allowing higher accuracy in relative positions to be maintained.

Furthermore, since lowering the stiffness of the bottom frame 20 more than that of the main frame assembly 11 causes the distortion of the bottom frame 20 to be relatively larger than that of the main frame assembly 11, the distortion of the main frame assembly 11 can be reduced to a small value, thereby further reducing misalignment of the optical components.

Further, since the projection display apparatus according to the present invention has the optical path elongated by reflecting back by the top mirror 3 the laser beam emitted from the optical engine 2, the depth-wise dimension of the apparatus can be made small, thus enabling thinness of the apparatus to be achieved. Moreover, as shown in FIG. 1, light is caused to reflect from the nonplanar mirror 205 so as to be diffused after it has been collected, thus enabling the apparatus to be further reduced in size. Further, as shown in FIG. 2, the upper side of the screen frame 5 and the outer end of each of slanted portions of the rear frame 6 are connected together; both upper end portions of the holding members 71 of the holding frame 7 and both ends of a portion, in parallel to the upper side of the main frame 5, of the rear frame 6 are connected together; and the lower portions of the holding frame 7 and the screen frame 5 are connected together. Thus, the frame structure takes the shape of the truss structure, thereby allowing the stiffness of the main frame assembly 11 to be enhanced.

Here, although the light source 101 is assumed to be configured by three laser generators emitting three laser beams, the number of laser beams emitted and the number of laser generators are not limited to this value. Further, when the image projected on the screen 4 is of mono color, the light source may be configured by using one laser generator that emits a laser beam of a particular wavelength.

Further, although each of the frames is secured by screws, it may be fixedly attached by another method such as welding or adhesive bonding.

### Embodiment 2

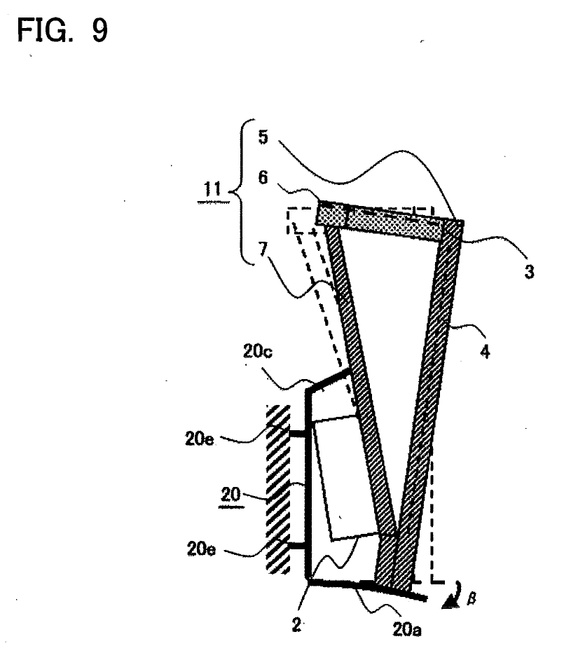

In Embodiment 1, the projection display apparatus mounted on a rack cabinet or installed on the floor has been described; however, it can also be mounted on a wall, as will be described below with reference to FIG. 9. FIG. 9 is a cross-sectional view showing the main frame assembly 11 and the bottom frame 20 in a situation where a projection display apparatus according to Embodiment 2 is hung on the wall. For comparison, shown in dotted lines is the side sectional view in a situation where no deformation due to its own weight occurs.

Referring to FIG. 9, the bottom frame 20 of the projection display apparatus is secured to the wall by screws or the like through four screw holes 20g formed at the straight sub-member 20d. In FIG. 9, because of the own weight of the main frame assembly 11, the moment about the connecting portions 20h to the wall serving as a pivot, acts on the bottom frame 20. As a result, the bottom members 20a and the slanted sub-members 20e of the bottom frame 20 deform in the direction of β in FIG. 9. However, because the stiffness of the main frame assembly 11 is set high with respect to the bottom frame 20, there is a small amount of deformation that occurs in the main frame assembly 11; as a result, each of the relative positional relationships between the optical engine 2, the top mirror 3 and the screen 4 remains unchanged and is maintained. In this way, when also mounted on the wall, the apparatus is hard to undergo the effect due to the deformation of the bottom frame 20.

As described above, because, in the projection display apparatus according to Embodiment 2, the main frame assembly 11 is placed via the bottom frame 20 on an installation object, deformations due to the condition of the installation object and the installation conditions occur in the bottom frame 20, which can reduce the deformations in the main frame assembly 11. Therefore, each of the relative positions of the optical engine 2, the top mirror 3 and the screen 4, can be maintained.

### Embodiment 3

Although in Embodiment 1 and Embodiment 2, laser beams emitted from the light source unit is caused to directly strike on the optical engine 2, the laser beams can be caused to strike there via transfer means for transferring them. Optical fibers can be used for the transfer means. When using the optical fibers, the laser beams transferred from each of the optical fibers may strike on the optical engine 2 by providing an optical fiber for each wavelength of light to be emitted from the light source unit 1. At this instance, as with Embodiment 1, the light of each wavelength can be combined together using a dichroic prism 201. On the other hand, when the diameter of an exit end of each optical fiber is sufficiently smaller than that of an entry end of a mixing rod 202 and if the emission light from any of the optical fibers is caused to strike on the mixing rod 202, the laser beams can be combined together without using the dichroic prism 201.

In this way, when using transfer means that flexibly varies its shape like the optical fibers, the light source unit 1 does not need to be disposed on the holding frame 7; by disposing the light source unit 1 on, for instance, the bottom frame 20, the light source unit 1 can be connected to the optical engine 2 using the optical fibers. Since disposing the light source unit 1 on the bottom frame 20 can reduce the optical component count retained by the main frame assembly 11, an advantage is that the distortion due to the weight of the optical components in the main frame assembly 11 is hard to generate. Here, the light source unit 1 may be placed on the main frame assembly 11, as with Embodiment 1.

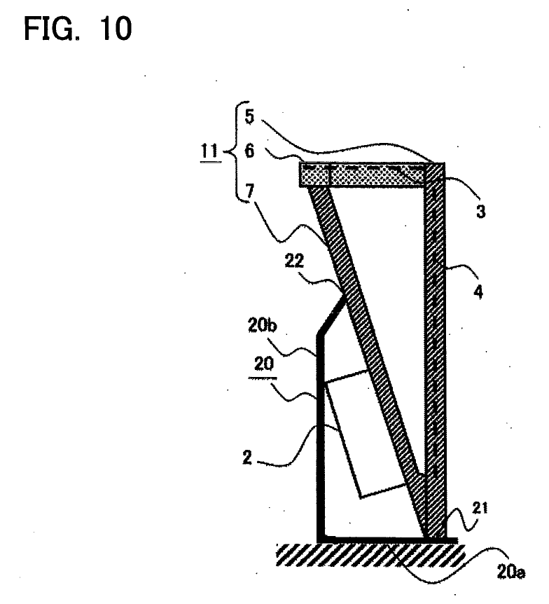

Although in Embodiment 1 through Embodiment 3 above, the lower end portion of the holding frame 7 is assumed to be screw-secured to the lower connecting portions 21 of the bottom frame 20, the lower end portions of the bottom frame 20 and the holding frame 7 do not need to be connected together; for instance, as shown in FIG. 10, by placing the main frame assembly 11 on the bottom frame 20, the screen frame 5 may be screw-secured to the bottom frame 20.

### Embodiment 4

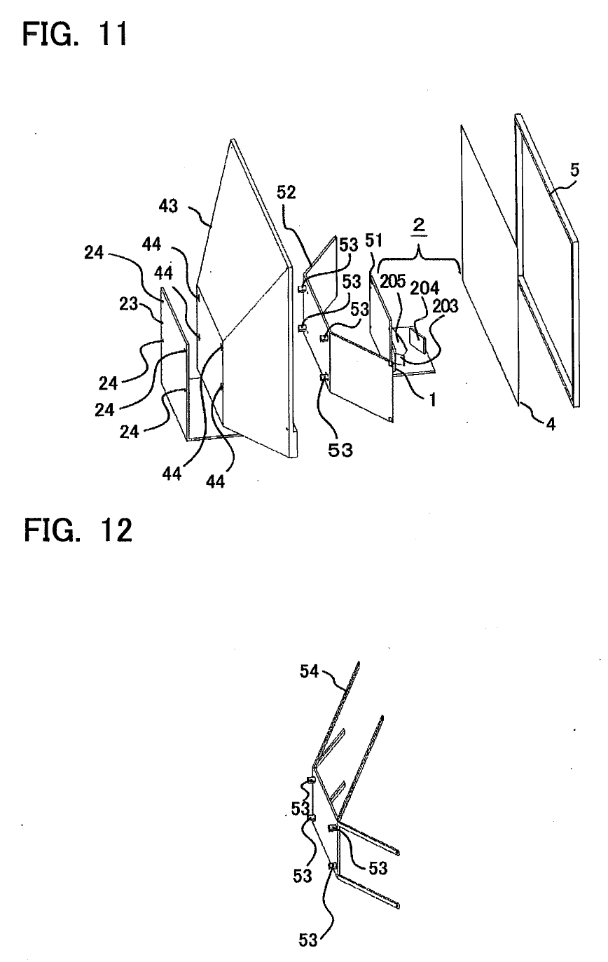

Although in Embodiment 1, the laser beams emitted from the optical engine 2 is assumed to be reflected by the top mirror 3, another method can be used without using the top mirror 3. FIG. 11 is an exploded perspective view of a projection display apparatus according to Embodiment 4. In FIG. 11, components that are the same as, or corresponding to, the components in FIGS. 1 through 3 bear the same numerals, and their description will not be provided herein.

Referring to FIG. 11, the light source unit 1 and the light source unit 2 are fixedly attached to the first supporting plate 51 whose vertical cross-section is L shaped. The optical engine 2 is configured with a DMD 203, a reflective mirror 204 and a nonplanar mirror 205. The light emitted from the light source unit 1 is reflected by the reflective mirror 204 after having demodulated by the DMD 203, and is further reflected by the nonplanar mirror 205 and then projected on the screen 4.

The first supporting plate 51 on which the optical engine 2 is mounted is secured to a second supporting plate 52. Further, the rear side of the projection display apparatus is covered with a rear cover 43. The second supporting plate 52 has four protrusion members 53 formed thereon. The second supporting plate 52 and a bottom frame 23 are secured together with the four protrusion members 53 passed through the four through-holes 24 drilled on the bottom frame 23. The four protrusion members 53 of the second supporting plate 52 and the four through-holes of the bottom frame 23 are provided at a location where other portions except the bottom frame 23 of the projection display apparatus hang in mid-air when the second supporting plate 52 is attached to the bottom frame 23.

The cabinet structure is configured such that the stiffness of the rear portion where the protrusion members 53 of the second supporting plate 52 are provided is higher than that of the bottom frame 23. With this configuration, even when the bottom frame 23 is distorted by the effect, etc. of the installation surface, the second supporting plate 52 is hard to distort, thus allowing the positional relationship between the nonplanar mirror 205 and the screen 4 to be maintained.

Here, the supporting plate 52 in Embodiment 4 is made up of a plate facing up to and in parallel with the surface of the screen 4, and two plates extending, toward the surface of the screen 4, outwardly diagonally from the right and left sides of the former plate; however, in lieu of the two plates fanning out from the right and left sides thereof, as shown in FIG. 12, six slender and light-weight rear frames 54 can be provided each two of which extend from the upper, right and left sides of the plate facing up to and in parallel with the surface of the screen 4.

Further, although the bottom frame 23 is made up of a single plate of L shape, it may be configured with a plurality of L-shaped members that are disposed with the right-left symmetry maintained. Configuration of the bottom frame 23 with the plurality of L-shaped members allows for reduction in the stiffness of the bottom frame 23.

Although in FIG. 11 the light source unit 1 is intended to be provided to the first supporting plate 51, it can be placed at a location other than the first supporting plate 51 by connecting the light source unit 1 and the optical engine 2 together using the optical fibers as in Embodiment 3.

Although in Embodiment 1 through Embodiment 4 above, the laser beam sources are used as the light source 101, a high intensity discharge lamp (HID) can be used as the light source. Since light emitted from the HID is white light, unlike the cases in the laser beam sources, the dichroic prism 201 that combines light from the light source together is not needed. Instead, however, a color wheel for converting the light from the light source 101 into the red, blue, and green colors needs to be placed between the mixing rod 202 and the DMD 203. LEDs can also be used as the light source 101. When using the LEDs, as with the cases in the laser beam sources, the light may be combined together using the dichroic prism 201, or combined together when the light is caused to strike on the mixing rod 202 after it has transmitted through the optical fibers.

Further, although, in Embodiment 1 through Embodiment 4 above, the main frame assembly 11 is assumed to be held by the bottom frame 20 and the supporting plate 52, by the bottom frame 23, the main frame assembly 11 and the supporting plate 52 may be designed to be placed directly against an installation object such as a wall. In this case, the stiffness of the main frame assembly 11 should be made higher so that the main frame assembly 11 may not distort when a force from the installation object is exerted thereon. While the present invention has been shown and described with reference to preferred embodiments thereof, it will be understood by those skilled in the art that various modifications and the like could be made thereto without departing from the spirit and scope of the invention.

What is claimed is:

1. A projection display apparatus, comprising:
a light source that emits light;
an optical engine that modulates light emitted from the light source;
a screen on which light emitted from the optical engine is projected;
a main frame assembly that holds the optical engine and the screen; and
a bottom frame that supports the main frame assembly.

2. The projection display apparatus of claim 1, wherein the bottom frame has lower stiffness than that of the main frame assembly.

3. The projection display apparatus of claim 2, wherein the main frame assembly includes a holding frame that holds the optical engine, a screen frame that is connected to the holding frame and holds the screen, and a rear frame that is connected to the holding frame and the screen frame, an upper end portion of the screen frame being connected to a first end portion of the rear frame, a second end portion of the rear frame being connected to an upper end portion of the holding frame, and a lower end portion of the holding frame being connected to a lower end portion of the screen frame.

4. The projection display apparatus of claim 3, wherein the bottom frame includes a bottom member connected to the screen frame, and a column member extending upwardly from the bottom member and connected to the holding frame.

5. The projection display apparatus of claim 4, wherein the column member includes a straight sub-member that is connected to the corresponding bottom member, and a slanted sub-member that is provided on an upper end portion of the straight sub-member and slants toward the holding frame relative to a longitudinal direction of the straight sub-member.

6. The projection display apparatus of claim 5, wherein the bottom frame includes a plurality of column members.

7. The projection display apparatus of claim 3, further comprising a reflective mirror that reflects the light emitted from the optical engine toward the screen, wherein the rear frame holds the reflective mirror.

8. The projection display apparatus of claim 4, further comprising under the bottom member a bottom portion of stiffness lower than that of the bottom member.

9. The projection display apparatus of claim 1, wherein the light source is provided at the main frame assembly and emits multi-wavelength light, and the optical engine includes a dichroic prism that combines together the multi-wavelength light emitted from the light source and modulates the light combined by the dichroic prism.

10. The projection display apparatus of claim 1, further comprising an optical fiber that transmits the light from the light source to the optical engine, wherein the light source is disposed on the bottom frame.

11. The projection display apparatus of claim 1, wherein the main frame assembly includes a holding frame that holds the optical engine, a screen frame that is connected to the holding frame and holds the screen, and a rear frame that is connected to the holding frame and the screen frame, an upper end portion of the screen frame being connected to a first end portion of the rear frame, a second end portion of the rear frame being connected to an upper end portion of the holding frame, and a lower end portion of the holding frame being connected to a lower end portion of the screen frame.

12. The projection display apparatus of claim 1, wherein the main frame assembly holds the optical engine and includes a holding frame to which the bottom frame is connected, and a surface of the holding frame where the bottom frame is connected has higher stiffness than that of the bottom frame.

13. The projection display apparatus of claim 12, further comprising under the bottom member a bottom portion of lower stiffness than that of the bottom member.

14. The projection display apparatus of claim 12, wherein the light source is provided at the main frame assembly and emits multi-wavelength light, and the optical engine includes a dichroic prism that combines together the multi-wavelength light emitted from the light source and modulates the light combined by the dichroic prism.

15. The projection display apparatus of claim 12, further comprising an optical fiber that transmits the light from the light source to the optical engine, wherein the light source is disposed on the bottom frame.

16. A projection display apparatus, comprising:
a light source that emits light;
an optical engine that modulates light emitted from the light source;
a screen on which light emitted from the optical engine is projected;
and
a main frame assembly including
a holding frame that holds the optical engine,
a screen frame that is connected to the holding frame and holds the screen, and
a rear frame that is connected to the holding frame and the screen frame;
wherein an upper end portion of the screen frame is connected to a first end portion of the rear frame, a second end portion of the rear frame is connected to an upper end portion of the holding frame, and a lower end portion of the holding frame is connected to a lower end portion of the screen frame.

17. The projection display apparatus of claim 16, wherein the light source is provided at the main frame assembly and emits multi-wavelength light, and the optical engine includes a dichroic prism that combines together the multi-wavelength light emitted from the light source and modulates the light combined by the dichroic prism.
